(19) United States
(12) Patent Application Publication
(10) Pub. No.: US 2011/0237694 A1
(43) Pub. Date: Sep. 29, 2011

(54) POLYARYLENE ETHERS WITH IMPROVED FLOWABILITY

(75) Inventors: Martin Weber, Maikammer (DE); Bernd Bruchmann, Freinsheim (DE); Christian Maletzko, Altrip (DE); Norbert Güntherberg, Speyer (DE)

(73) Assignee: BASF SE, Ludwigshafen (DE)

(21) Appl. No.: 13/069,839

(22) Filed: Mar. 23, 2011

Related U.S. Application Data
(60) Provisional application No. 61/316,395, filed on Mar. 23, 2010.

(51) Int. Cl. C08L 81/06; C08L 69/00; C08L 67/00; C08J 9/35; C08K 7/14

(52) U.S. Cl. 521/134; 524/537; 524/539

(57) ABSTRACT

The present invention relates to thermoplastic molding compositions comprising the following components:
(A) at least one polyarylene ether,
(B) at least one hyperbranched polymer selected from hyperbranched polycarbonates and hyperbranched polyesters,
(C) optionally at least one fibrous or particulate filler, and
(D) optionally further additives and/or processing aids.

The present invention further relates to a process for producing the thermoplastic molding compositions of the invention, to their use for producing moldings, fibers, foams, films, or membranes, and to the resultant moldings, fibers, foams, films, and membranes.

The present invention relates to thermoplastic molding compositions comprising the following components:
(A) at least one polyarylene ether,
(B) at least one hyperbranched polymer selected from hyperbranched polycarbonates and hyperbranched polyesters,
(C) optionally at least one fibrous or particulate filler, and
(D) optionally further additives and/or processing aids.

The present invention further relates to a process for producing the thermoplastic molding compositions of the invention, to their use for producing moldings, fibers, foams, films, or membranes, and to the resultant moldings, fibers, foams, films, and membranes.

Polyarylene ethers are engineering thermoplastics, and the high heat resistance and high chemicals resistance of these materials leads to their use in very demanding applications. Polyarylene ethers are amorphous and therefore often have inadequate resistance to aggressive solvents. Polyarylene ethers also have high melt viscosity, and this is particularly disadvantageous for processing to give large moldings by means of injection molding. The high melt viscosity is particularly disadvantageous for producing molding compositions with high filler loading or high fiber loading.

The abbreviated term polysulfones is often used for polyarylene ether sulfones, and these are a particularly important class of compound within the polyarylene ether class. Polyarylene ether sulfones are described by way of example in Herman F. Mark, “Encyclopedia of Polymer Science and Technology”, 3rd edition, Volume 4, 2003, chapter on “Polysulfones”.

The flowability of the polyarylene ethers known from the prior art is unsatisfactory for many applications. Furthermore, the impact resistance of the known polyarylene ethers is often insufficient. There is moreover often an unsatisfactorily high degree of anisotropy in respect of stiffness (modulus of elasticity) in reinforced molding compositions based on polyarylene ethers, in particular those comprising fibrous fillers.

The object of the present invention therefore consisted in providing thermoplastic molding compositions which are based on polyarylene ethers and which do not have the abovementioned disadvantages or have these to a relatively small extent. In particular, the thermoplastic molding compositions should have improved flowability. At the same time, the thermoplastic molding compositions should have good mechanical properties, in particular improved impact resistance and notched impact resistance. A further intention was to improve anisotropy in respect of stiffness in reinforced thermoplastic molding compositions.

The abovementioned objects are achieved via the thermoplastic molding compositions of the invention. Preferred embodiments can be found in the claims and in the description below. Combinations of preferred embodiments are within the scope of the present invention.

The thermoplastic molding compositions of the invention comprise the following components:
(A) at least one polyarylene ether,
(B) at least one hyperbranched polymer selected from hyperbranched polycarbonates and hyperbranched polyesters,
(C) optionally at least one fibrous or particulate filler, and
(D) optionally further additives and/or processing aids.

It is preferable that the thermoplastic molding compositions of the present invention comprise the following components:
(A) at least one polyarylene ether,
(B) at least one hyperbranched polymer selected from hyperbranched polycarbonates and hyperbranched polyesters,
(C) at least one fibrous or particulate filler, and
(D) optionally further additives and/or processing aids.

The thermoplastic molding compositions of the present invention preferably comprise from 90 to 99.9% by weight of component (A) and from 0.1 to 10% by weight of component (B), where the entirety of the % by weight values of components (A) and (B), based on the entire amount of components (A) and (B), is 100% by weight.

The thermoplastic molding compositions of the present invention particularly preferably comprise
from 25 to 94.9% by weight, in particular from 35 to 89.5% by weight, of component (A),
from 0.1 to 5% by weight, in particular from 0.5 to 3% by weight, of component (B),
from 5 to 70% by weight, in particular from 10 to 62% by weight, of component (C), and
from 0 to 40% by weight, in particular from 0 to 20% by weight, of component (D),
   where the entirety of the % by weight values of components (A) to (D), based on the entire amount of components (A) to (D), is 100% by weight.

A more detailed explanation of the individual components is given below.

### Component A

In the invention, the thermoplastic molding compositions comprise at least one polyarylene ether (A).

Polyarylene ethers are a class of polymer known to the person skilled in the art. In principle, any of the polyarylene ethers that are known to the person skilled in the art and/or that can be produced by known methods can be used as constituent of component (A). Preference is given here to polyarylene ether sulfones.

Preferred polyarylene ethers (A) are composed of units of the general formula I:

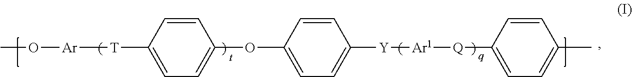

where the definitions of the symbols t, q, Q, T, Y, Ar, and Ar¹ are as follows:
t, q: independently of one another 0, 1, 2, or 3,
Q, T, Y: independently of one another in each case a chemical bond or group selected from —O—, —S—, —SO₂—, S═O, C═O, —N═N— and —CR^{a}R^{b}—, where R^{a} and R^{b} independently of one another are in each case a hydrogen atom or a C₁-C₁₂-alkyl, C₁-C₁₂-alkoxy or C₆-C₁₈-aryl group, and where at least one of Q, T and Y is —SO₂— and
Ar, Ar¹: independently of one another an arylene group having from 6 to 18 carbon atoms.

If, within the abovementioned preconditions, Q, T or Y is a chemical bond, this then means that the adjacent group on the left-hand side and the adjacent group on the right-hand side are present with direct linkage to one another via a chemical bond.

However, it is preferable that Q, T, and Y in formula I are selected independently of one another from —O— and —SO₂—, with the proviso that at least one of the group consisting of Q, T, and Y is —SO₂—.

If Q, T, or Y is —CR^{a}R^{b}—, R^{a} and R^{b} independently of one another are in each case a hydrogen atom or a C₁-C₁₂-alkyl, C₁-C₁₂-alkoxy, or C₆-C₁₈-aryl group.

Preferred C₁-C₁₂-alkyl groups comprise linear and branched, saturated alkyl groups having from 1 to 12 carbon atoms. The following moieties may be mentioned in particular: C₁-C₆-alkyl moiety, e.g. methyl, ethyl, n-propyl, isopropyl, n-butyl, sec-butyl, 2- or 3-methylpentyl, and longer chain moieties, e.g. unbranched heptyl, octyl, nonyl, decyl, undecyl, lauryl, and the singly branched or multibranched analogs thereof.

Alkyl moieties that can be used in the abovementioned C₁-C₁₂-alkoxy groups that can be used are the alkyl groups defined at an earlier stage above having from 1 to 12 carbon atoms. Cycloalkyl moieties that can be used with preference in particular comprise C₃-C₁₂-cycloalkyl moieties, e.g. cyclopropyl, cyclobutyl, cyclopentyl, cyclohexyl, cycloheptyl, cyclooctyl, cyclopropylmethyl, cyclopropylethyl, cyclopropyl-propyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a C₆-C₁₈-arylene group. On the basis of the starting materials described at a later stage below, it is preferable that Ar derives from an electron-rich aromatic substance that is very susceptible to electrophilic attack, preferably selected from the group consisting of hydroquinone, resorcinol, dihydroxy-naphthalene, in particular 2,7-dihydroxynaphthalene, and 4,4′-bisphenol. Ar¹ is preferably an unsubstituted C₆- or C₁₂-arylene group.

Particular C₆-C₁₈-arylene groups Ar and Ar¹ that can be used are phenylene groups, e.g. 1,2-, 1,3-, and 1,4-phenylene, naphthylene groups, e.g. 1,6-, 1,7-, 2,6-, and 2,7-naphthylene, and also the arylene groups that derive from anthracene, from phenanthrene, and from naphthacene.

In the preferred embodiment according to formula I, it is preferable that Ar and Ar¹ are selected independently of one another from the group consisting of 1,4-phenylene, 1,3-phenylene, naphthylene, in particular 2,7-dihydroxynaphthylene, and 4,4′-bisphenylene.

Preferred polyarylene ethers (A) are those which comprise at least one of the following repeat structural units Ia to Io:

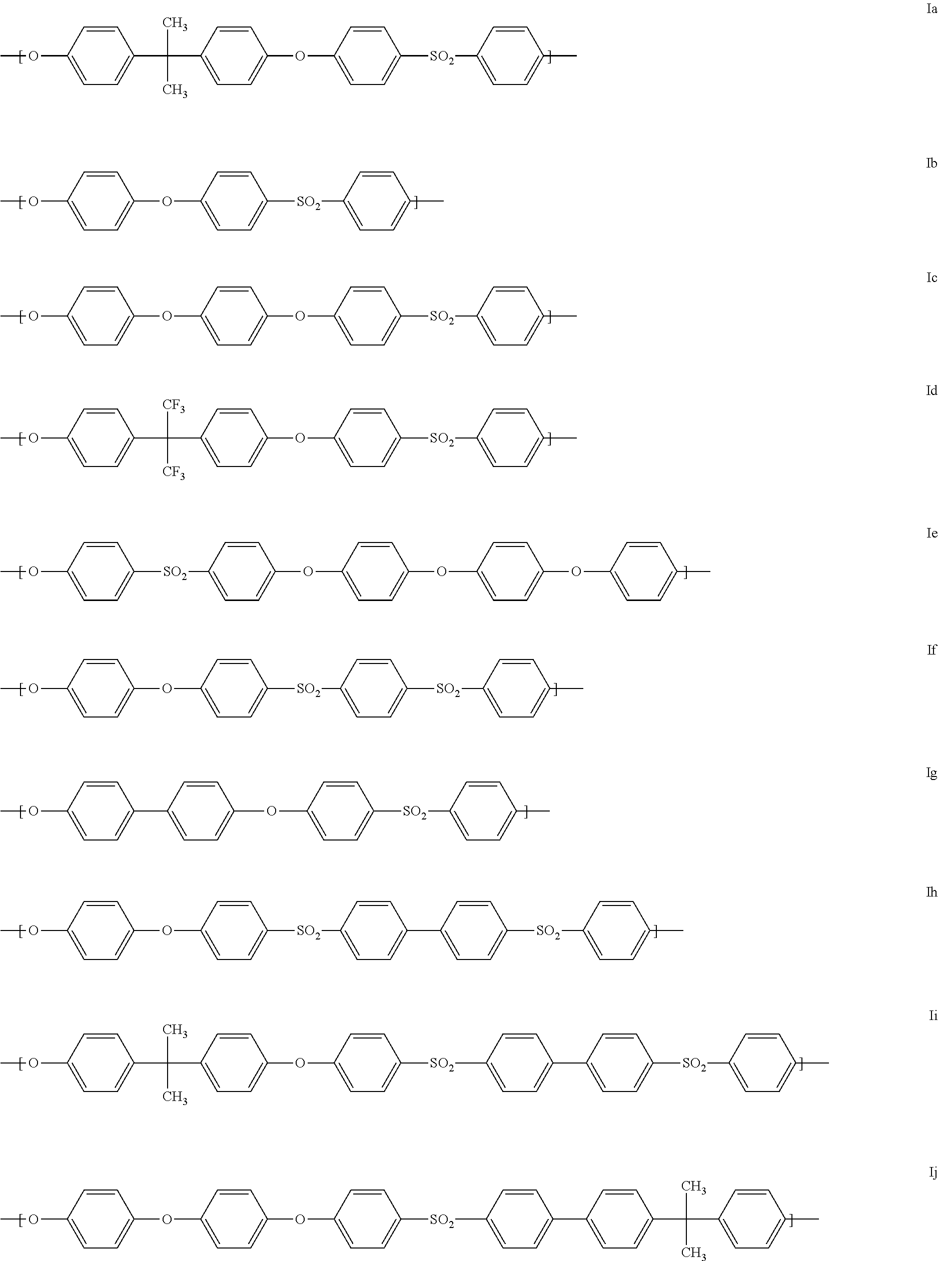

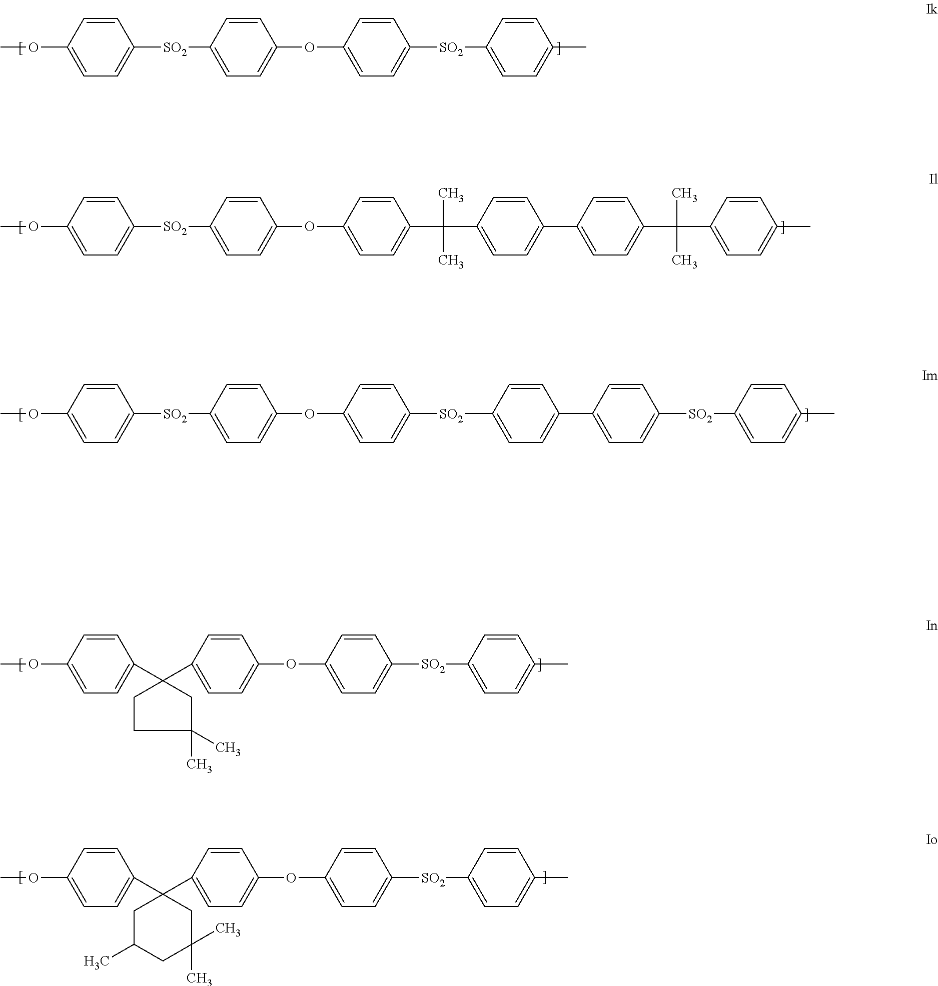

Other units to which preference is given, in addition to the preferred units Ia to Io, are those in which one or more 1,4-phenylene units deriving from hydroquinone have been replaced by 1,3-phenylene units deriving from resorcinol, or by naphthylene units deriving from dihydroxynaphthalene.

Particularly preferred units of the general formula I are the units Ia, Ig, and Ik. It is also particularly preferable that the polyarylene ethers of component (A) are in essence composed of one type of unit of the general formula I, in particular of one unit selected from Ia, Ig, and Ik.

In one particularly preferred embodiment, Ar=1,4-phenylene, t=1, q=0, T is a chemical bond, and Y═SO₂. Particularly preferred polyarylene ether sulfones (A) composed of the abovementioned repeat unit are termed polyphenylene sulfone (PPSU).

In another particularly preferred embodiment, Ar=1,4-phenylene, t=1, q=0, T=C(CH₃)₂, and Y═SO₂. Particularly preferred polyarylene ether sulfones (A) composed of the abovementioned repeat unit are termed polysulfone (PSU).

In another particularly preferred embodiment, Ar=1,4-phenylene, t=1, q=0, T=Y=SO₂. Particularly preferred polyarylene ether sulfones (A) composed of the abovementioned repeat unit are termed polyether sulfone (PESU). This embodiment is very particularly preferred.

For the purposes of the present invention, abbreviations such as PPSU, PESU, and PSU are in accordance with DIN EN ISO 1043-1:2001.

The average molar masses Mₙ (number average) of the preferred polyarylene ethers (A) are generally in the range from 5000 to 60 000 g/mol, with relative viscosities of from 0.20 to 0.95 dl/g. The relative viscosities of the polyarylene ethers are determined in 1% strength by weight N-methylpyrrolidone solution at 25° C. to DIN EN ISO 1628-1.

The weight-average molar masses M_{w} of the polyarylene ethers (A) of the present invention are preferably from 10 000 to 150 000 g/mol, in particular from 15 000 to 120 000 g/mol, particularly preferably from 18 000 to 100 000 g/mol, determined by means of gel permeation chromatography in dimethylacetamide solvent against narrowly distributed polymethyl methacrylate as standard.

Production processes that lead to the abovementioned polyarylene ethers are known per se to the person skilled in the art and are described by way of example in Herman F. Mark, “Encyclopedia of Polymer Science and Technology”, third edition, volume 4, 2003, “Polysulfones” chapter, pages 2 to 8, and also in Hans R. Kricheldorf, “Aromatic Polyethers” in: Handbook of Polymer Synthesis, second edition, 2005, pages 427 to 443.

Particular preference is given to the reaction, in aprotic polar solvents and in the presence of anhydrous alkali metal carbonate, in particular sodium carbonate, potassium carbonate, calcium carbonate, or a mixture thereof, very particularly preferably potassium carbonate, between at least one aromatic compound having two halogen substituents and at least one aromatic compound having two functional groups reactive toward abovementioned halogen substituents. One particularly suitable combination is N-methylpyrrolidone as solvent and potassium carbonate as base.

It is preferable that the polyarylene ethers (A) have either halogen end groups, in particular chlorine end groups, or etherified end groups, in particular alkyl ether end groups, these being obtainable via reaction of the OH or, respectively, phenolate end groups with suitable etherifying agents.

Examples of suitable etherifying agents are monofunctional alkyl or aryl halide, e.g. C₁-C₆-alkyl chloride, C₁-C₆-alkyl bromide, or C₁-C₆-alkyl iodide, preferably methyl chloride, or benzyl chloride, benzyl bromide, or benzyl iodide, or a mixture thereof. For the purposes of the polyarylene ethers of component (A) preferred end groups are halogen, in particular chlorine, alkoxy, in particular methoxy, aryloxy, in particular phenoxy, or benzyloxy.

### Component B

According to the invention, the thermoplastic molding compositions comprise, as component (B), at least one hyperbranched polymer selected from hyperbranched polycarbonates and hyperbranched polyesters.

The molding compositions of the invention preferably comprise from 0.1 to 10% by weight, in particular from 0.1 to 5% by weight, and particularly preferably from 0.5 to 3% by weight, of component (B), based on the entire amount of components (A) to (D).

For the purposes of the invention, the meaning of the term “hyperbranched” is that the degree of branching DB of the relevant polymers, defined as DB (%)=100×(T+Z)/(T+Z+L), where T is the average number of terminally bonded monomer units, Z is the average number of monomer units forming branching systems, and L is the average number of linearly bonded monomer units in the macromolecules of the respective substances, is from 10 to 99%, preferably from 25 to 90%, and particularly preferably from 30 to 80%. For the purposes of the present invention, the term “hyperbranched” is used synonymously with “highly branched”. Hyperbranched polymers must not be confused with dendrimers. For the definition of “degree of branching”, see H. Frey et al., Acta Polym. 1997, 48, 30. For the definition of the term “hyperbranched”, see Sunder et al., Chem. Eur. J. 2000, 6 (14), 2499-2506.

Dendrimers are polymers having a perfectly symmetrical structure, and can be produced by starting from a central molecule and using controlled stepwise linkage of respectively two or more di- or polyfunctional monomers to each previously bonded monomer. Every linkage step here multiplies the number of monomer end groups (and therefore the number of linkages), and the products are polymers having tree-like structures, ideally spherical, where each of the branches comprises exactly the same number of monomer units. By virtue of said perfect structure, the properties of the polymer are often advantageous, examples observed being low viscosity and high reactivity, due to the large number of functional groups at the surface of the sphere. However, a factor that complicates the production process is that every linkage step requires introduction and, in turn, removal of protective groups, and purification operations are required, and for this reason it is usual to produce dendrimers only on a laboratory scale.

However, hyperbranched polymers can be produced by large-scale industrial processes. Hyperbranched polymers have not only perfect dendritic structures but also linear polymer chains and unequal polymer branches, but this does not significantly impair the properties of the polymer in comparison with those of perfect dendrimers. Hyperbranched polymers can in particular be produced by way of two synthetic routes, known as AB2 and Aₓ+B_{y}. A and B here represent different monomer units, and the indices x and y represent the number of reactive functional groups comprised in A and, respectively, B, i.e. the functionality of A and, respectively, B. In the AB2 route, a trifunctional monomer having one reactive group A and two reactive groups B is reacted to give a highly branched or hyperbranched polymer. In the Aₓ and B_{y} synthesis, taking the example of the A₂+B₃ synthesis, a difunctional monomer A₂ is reacted with a trifunctional monomer B₃. This initially gives a 1:1 adduct made of A and B having an average of one functional group A and two functional groups B, and this can then likewise react to give a hyperbranched polymer.

The hyperbranched (non-dendrimeric) polymers used in the invention differ from dendrimers in the degree of branching defined above. In the context of the present invention, the polymers are “dendrimeric” when their degree of branching DB is from 99.9 to 100%. A dendrimer therefore has the maximum possible number of branching points, this number being achievable only by virtue of a highly symmetrical structure.

Preferred hyperbranched polycarbonates have an OH number of from 1 to 600 mg KOH/g of polycarbonate, preferably from 10 to 550 mg KOH/g of polycarbonate, and in particular from 50 to 550 mg KOH/g of polycarbonate (to DIN 53240, part 2), and are hereinafter termed hyperbranched polycarbonates B1).

Preferred hyperbranched polyesters are those of Aₓ B_{y} type, where A and B characterize different monomer units and x is at least 1, in particular at least 1.1, and y is at least 2, in particular at least 2.1, and are hereinafter termed hyperbranched polyesters B2).

For the purposes of the invention, hyperbranched polycarbonates B1) are uncrosslinked macromolecules having hydroxy and carbonate groups and having both structural and molecular nonuniformity. They can firstly be composed of a central molecule by analogy with dendrimers, but with nonuniform chain lengths of the branches. Secondly, they can also be of linear structure, having functional pendent groups, or else, combining the two extremes, can have linear and branched portions of the molecule.

The number-average molar mass Mn of the preferred hyperbranched polycarbonates B1) is preferably from 100 to 15 000 g/mol, preferably from 200 to 12 000 g/mol, and in particular from 500 to 10 000 g/mol (GPC, PMMA standard). The glass transition temperature Tg is in particular from −80° C. to +140, preferably from −60 to 120° C. (by DSC, DIN 53765). Viscosity at 23° C. (to DIN 53019) is in particular from 50 to 200 000 mPas, in particular from 100 to 150 000 mPas, and very particularly preferably from 200 to 100 000 mPas.

Hyperbranched polycarbonates are known per se or can be produced by methods known per se.

Hyperbranched polycarbonates B1) are preferably obtainable via a process which comprises at least the following steps:
alternative aa) reaction of at least one organic carbonate (G) of the general formula RO[(CO)]ₙOR with at least one aliphatic, aliphatic/aromatic, or aromatic alcohol (H) which has at least 3 OH groups, with elimination of alcohols ROH to give one or more condensates (K), where each R independently of the others is a straight-chain or branched aliphatic, aromatic/aliphatic, or aromatic hydrocarbon radical having from 1 to 20 carbon atoms, and where the radicals R can also have bonding to one another to form a ring, and n is an integer from 1 to 5, or
alternative ab) reaction of phosgene, diphosgene, or triphosgene with abovementioned alcohol (H) with elimination of hydrogen chloride, and also, subsequent to aa) and, respectively, ab)
intermolecular reaction of the condensates (K) to give a high-functionality, highly branched or hyperbranched polycarbonate,
   where the quantitative proportion of the OH groups with respect to the carbonates in the reaction mixture is selected in such a way that the condensates (K) have an average of either one carbonate group and more than one OH group or one OH group and more than one carbonate group.

The starting material used can comprise phosgene, diphosgene, or triphosgene, but preference is given here to organic carbonates.

Each of the radicals R of the organic carbonates (G) used as starting material and having the general formula RO(CO)ₙOR is independently of the others a straight-chain or branched aliphatic, aromatic/aliphatic, or aromatic hydrocarbon radical having from 1 to 20 carbon atoms. The two radicals R can also have bonding to one another to form a ring. Preference is given to an aliphatic hydrocarbon radical and particular preference is given to a straight-chain or branched alkyl radical having from 1 to 5 carbon atoms, or a substituted or unsubstituted phenyl radical.

In particular, simple carbonates of the formula RO(CO)ₙOR are used; n is preferably from 1 to 3, in particular 1.

Corresponding dialkyl or diaryl carbonates are known and can by way of example be produced from the reaction of aliphatic, araliphatic, or aromatic alcohols, preferably monoalcohols, with phosgene. They can also be produced via oxidative carbonylation of the alcohols or phenols by means of CO in the presence of noble metals, oxygen, or NOₓ. For methods used to produce diaryl or dialkyl carbonates, see also “Ullmann's Encyclopedia of Industrial Chemistry”, 6th Edition, 2000 Electronic Release, Verlag Wiley-VCH.

Examples of suitable carbonates comprise aliphatic, aromatic/aliphatic, or aromatic carbonates, such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates in which n is greater than 1 comprise dialkyl dicarbonates, such as di(t-butyl) dicarbonate, or dialkyl tricarbonates, such as di(t-butyl) tricarbonate.

It is preferable to use aliphatic carbonates, in particular those in which the radicals comprise from 1 to 5 carbon atoms, examples being dimethyl carbonate, diethyl carbonate, dipropyl carbonate, dibutyl carbonate, and diisobutyl carbonate.

The organic carbonates (G) are reacted with at least one aliphatic alcohol (H) which has at least 3 OH groups, or with a mixture of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl) isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, or sugars, e.g. glucose, tri- or polyfunctional polyetherols based on alcohols of functionality three or higher and ethylene oxide, propylene oxide, or butylene oxide, or polyesterols. Particular preference is given here to glycerol, trimethylolethane, trimethylolpropane, 1,2,4-butanetriol, and pentaerythritol, and also to polyetherols of these based on ethylene oxide or propylene oxide.

Said polyfunctional alcohols can also be used in a mixture with difunctional alcohols (H′), with the proviso that the average overall OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, difunctional polyether polyols based on ethylene oxide, propylene oxide, butylene oxide, or a mixture of these, polytetrahydrofuran, polycaprolactone, or polyesterols based on diols and dicarboxylic acids.

The diols serve for fine adjustment of the properties of the polycarbonate. If difunctional alcohols are used, the ratio of difunctional alcohols H′) to the at least trifunctional alcohols (H) is established by the person skilled in the art as a function of the properties desired in the polycarbonate. The amount of the alcohol(s) (H′) used is generally from 0 to 39.9 mol %, based on the total amount of all of the alcohols (H) and (H′). The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the high-functionality hyperbranched polycarbonate of the invention takes place with elimination of the monofunctional alcohol or phenol from the carbonate molecule.

The high-functionality hyperbranched polycarboantes B1) formed by the preferred process have termination by hydroxy groups and/or by carbonate groups after the reaction, i.e. without further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a high-functionality polycarbonate is a product which also has, alongside the carbonate groups which form the main structure of the polymer, at least three, preferably at least six, more preferably at least ten, terminal or pendent functional groups. The functional groups are carbonate groups and/or OH groups. The number of terminal or pendent functional groups is not in principle subject to any upward restriction, but products having a very large number of functional groups can have unwanted properties, such as high viscosity or poor solubility. The high-functionality polycarbonates of the present invention mostly have no more than 500 terminal or pendent functional groups, preferably no more than 100 terminal or pendent functional groups.

In producing the high-functionality polycarbonates B1) it is necessary to set the ratio of the compounds comprising OH groups to phosgene or carbonate in such a way that the simplest resultant condensate (hereinafter termed condensate (K)) has an average of either one carbonate group or carbamoyl group and more than one OH group or one OH group and more than one carbonate group or carbamoyl group. The simplest arrangement here in the structure of the condensate (K) derived from a carbonate (G) and from a di- or polyalcohol is XYₙ or YₙX, where X is a carbonate group, Y is a hydroxy group, and n is generally a number from 1 to 6, preferably from 1 to 4, particularly preferably from 1 to 3. The reactive group which is the resultant single group is generally termed “focal group” hereinafter.

Corresponding reactions of carbonates (G) with di- or polyalcohols using various reaction ratios and optionally in the presence of additional difunctional compounds as chain extenders are known and are disclosed by way of example in WO 2008/074687, from line 29 on page 13 to line 12 on page 18, and the contents of that document are hereby expressly incorporated by way of reference.

Because of the nature of the condensates (K) it is possible that the condensation reaction can give polycondensates (P) having different structures, where these have branching systems but no crosslinking. Ideally the polycondensates (P) moreover have either one carbonate group as focal group and more than two OH groups or else one OH group as focal group and more than two carbonate groups. The number of reactive groups here is the result of the nature of the condensates (K) used and of the degree of polycondensation.

In another preferred embodiment, the preferred polycarbonates B1) can comprise further functional groups alongside the functional groups intrinsically obtained via the reaction. This functionalization can take place during the process of increasing molecular weight or else subsequently, i.e. after conclusion of the actual polycondensation process.

If, prior to or during the process of increasing molecular weight, components are added which have further functional groups alongside hydroxy or carbonate groups, or which possess functional elements, the product is a polycarbonate polymer having randomly distributed functionalities that differ from the carbonate or hydroxy groups.

Effects of this type can by way of example be obtained via addition of compounds during the polycondensation process, where these bear not only hydroxy groups, carbonate groups, or carbamoyl groups, but also further functional groups or functional elements, examples being mercapto groups, primary, secondary, or tertiary amino groups, ether groups, silane groups, siloxane groups, aryl radicals or long-chain alkyl radicals, or derivatives of carboxylic acids or derivatives of sulfonic acids or derivatives of phosphonic acids. Examples of compounds that can be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol, or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)-aminomethane, ethylenediamine, propylenediamine, hexamethylenediamine, or isophoronediamine.

For the modification process using mercapto groups, mercaptoethanol can be used, for example. Tertiary amino groups can be produced by way of example via incorporation of N-methyldiethanolamine, N-methyldipropanolamine, or N,N-dimethylethanolamine. Ether groups can be generated by way of example via a condensation process that includes di- or polyfunctional polyetherols. Reaction with long-chain alkanediols can be used to introduce long-chain alkyl radicals and with alkyl or aryl diisocyanates generates polycarbonates having alkyl, aryl, and urethane groups, or urea groups. Addition of dicarboxylic acids, tricarboxylic acids, or, for example, dimethyl terephthalate, or tricarboxylic esters can produce ester groups.

Subsequent functionalization can be obtained by using an additional step (step c)) to react the resultant high-functionality hyperbranched polycarbonate with a suitable functionalizing reagent, which can react with the OH and/or carbonate groups, or carbamoyl groups, of the polycarbonate.

High-functionality hyperbranched polycarbonates comprising hydroxy groups can by way of example be modified via addition of molecules comprising acid groups or of molecules comprising isocyanate groups. By way of example, polycarbonates comprising acid groups can be obtained via reaction with compounds comprising anhydride groups.

High-functionality polycarbonates comprising hydroxy groups can moreover also be converted to high-functionality polycarbonate polyether polyols via reaction with alkylene oxides, e.g. ethylene oxide, propylene oxide, or butylene oxide.

The molding compositions of the invention can comprise, as preferred hyperbranched polymer, at least one hyperbranched polyester B2) of AₓB_{y} type, where x is at least 1, in particular at least 1.1, preferably at least 1.3, particularly preferably at least 2, and y is at least 2, in particular at least 2.1, preferably at least 2.5, particularly preferably at least 3.

A polyester of AₓB_{y} type is a condensate which forms from an x-functional molecule A and from a y-functional molecule B. By way of example, mention may be made of a polyester derived from adipic acid as molecule A (x=2) and glycerol as molecule B (y=3).

For the purposes of this invention, hyperbranched polyesters B2) are uncrosslinked macromolecules having hydroxy and carboxy groups and having both structural and molecular nonuniformity. They can firstly be composed of a central molecule by analogy with dendrimers, but with nonuniform chain lengths of the branches. Secondly, they can also be of linear structure, having functional pendent groups, or else, combining the two extremes, can have linear and branched portions of the molecule.

The Mn of the hyperbranched polyesters B2) is preferably from 300 to 30 000 g/mol, in particular from 400 to 25 000 g/mol, and very particularly from 500 to 20 000 g/mol, determined by means of GPC, PMMA standard, dimethylacetamide eluent.

The hyperbranched polyesters B2) preferably have an OH number of from 0 to 600 mg KOH/g of polyester, preferably from 1 to 500 mg KOH/g of polyester, in particular from 20 to 500 mg KOH/g of polyester, to DIN 53240, and also preferably have a COOH number of from 0 to 600 mg KOH/g of polyester, preferably from 1 to 500 mg KOH/g of polyester, and in particular from 2 to 500 mg KOH/g of polyester. The Tg is preferably from −50° C. to 140° C. and in particular from −50 to 100° C. (by means of DSC, to DIN 53765).

Preference is in particular given to those hyperbranched polyesters B2) in which at least one OH number or COOH number is greater than 0, preferably greater than 0.1, and in particular greater than 0.5.

The preferred hyperbranched polyesters B2) are preferably obtainable by reacting
(a) one or more dicarboxylic acids or one or more derivatives of the same with one or more at least trifunctional alcohols, or
(b) one or more tricarboxylic acids or higher polycarboxylic acids, or one or more derivatives of the same, with one or more diols
   in the presence of a solvent and optionally in the presence of an inorganic, organometallic, or low-molecular-weight organic catalyst, or of an enzyme. The reaction in a solvent is the preferred method of production.

For the purposes of the present invention, high-functionality hyperbranched polyesters B2) have molecular and structural nonuniformity. By virtue of their molecular nonuniformity, they differ from dendrimers, therefore being considerably easier to produce.

Among the dicarboxylic acids that can be reacted by variant (a) are in particular oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and also cis- and trans-cyclopentane-1,3-dicarboxylic acid, where the abovementioned dicarboxylic acids can have substitution by one or more radicals selected from
C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, or n-decyl,
C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preferably cyclopentyl, cyclohexyl and cycloheptyl;
alkylene groups, such as methylene, or ethylidene, or
C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Suitable representatives that may be mentioned for substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids that can be reacted by variant (a) are also ethylenically unsaturated acids, e.g. maleic acid and fumaric acid, and also aromatic dicarboxylic acids, such as phthalic acid, isophthalic acid, or terephthalic acid. Mixtures of two or more of the abovementioned representatives can also be used. The dicarboxylic acids can be used either as they stand or in the form of derivatives.

Derivatives are preferably
the relevant anhydrides in monomeric or else polymeric form,
mono- or dialkyl esters, preferably mono- or dimethyl esters, or the corresponding mono- or diethyl esters, but also the mono- and dialkyl esters derived from higher alcohols, such as n-propanol, isopropanol, n-butanol, isobutanol, tert-butanol, n-pentanol, n-hexanol, and also
mono- and divinyl esters, and also
mixed esters, preferably methyl ethyl esters.

For the purposes of the preferred production process it is also possible to use a mixture of a dicarboxylic acid and of one or more derivatives thereof. It is equally possible to use a mixture of a plurality of various derivatives of one or more dicarboxylic acids.

It is particularly preferable to use succinic acid, glutaric acid, adipic acid, phthalic acid, isophthalic acid, terephthalic acid, or mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylol-propane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid. Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else
mono-, di-, or trivinyl esters, and
mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain component B2).

Examples of diols used for variant (b) of the preferred process are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethyl-pentane-2,4-diol, 2-ethylhexane-1,3-diol, 2,5-dimethylhexane-2,5-diol, 2,2,4-trimethyl-pentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH_{3]}CH₂O)ₙ—H or mixtures of two or more representative compounds of the above compounds, where n is a whole number and n=from 4 to 25. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may derive either from chemical causes (e.g. primary/secondary/tertiary OH group) or from steric causes. By way of example, the triol may comprise a triol which has primary and secondary hydroxy groups, a preferred example being glycerol.

When the inventive reaction is carried out according to variant (a), it is preferable to operate in the absence of diols and of monohydric alcohols. When the inventive reaction is carried out according to variant (b), it is preferable to operate in the absence of mono- or dicarboxylic acids.

The production of the hyperbranched polyesters B2) preferred in the present invention is known and is disclosed by way of example in WO 2007/074687, on page 24, line 37 to page 28, line 33, the content of which is expressly incorporated herein by way of reference.

The molar mass Mw of the preferred hyperbranched polyesters B2) is from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They usually have good solubility, i.e. clear solutions can be prepared at up to 50% by weight, indeed in some instances up to 80% by weight, of the polyesters of the invention in tetrahydrofuran (THF), n-butyl acetate, ethanol, and numerous other solvents, without any gel particles detectable by the naked eye.

The high-functionality hyperbranched polyesters B2) are preferably carboxy-terminated, or terminated by carboxy and hydroxy groups, and particularly preferably terminated by hydroxy groups.

When hyperbranched polymers of type B1) and B2) are used in a mixture, the ratio by weight of component B1) to B2) is preferably from 1:20 to 20:1, in particular from 1:15 to 15:1, and very particularly from 1:5 to 5:1.

The hyperbranched polycarbonates B1) and polyesters B2) used are respectively preferably particles of size from 20 to 500 nm, in particular from 30 to 400 nm, very particularly preferably from 50 to 300 nm. These nanoparticles are present in finely dispersed form within the polymer blend, and the size of the particles within the compounded material is from 20 to 500 nm, preferably from 50 to 300 nm.

### Component C

The thermoplastic molding compositions of the present invention comprise, as component (C), preferably at least one fibrous or particulate filler, the amount of which is particularly preferably from 5 to 70% by weight, very particularly preferably from 10 to 70% by weight, in particular from 10 to 62% by weight, based on a total of 100% by weight of components (A) to (D).

The molding compositions of the invention can in particular comprise particulate or fibrous fillers, particular preference being given to fibrous fillers.

Preferred fibrous fillers are carbon fibers, potassium titanate whiskers, aramid fibers, and particularly preferably glass fibers. If glass fibers are used, these can have been equipped with a size, preferably with a polyurethane size, and with a coupling agent, to improve compatibility with the matrix material. The diameter of the carbon fibers and glass fibers used is generally in the range from 6 to 20 μm. Component (C) is therefore particularly preferably composed of glass fibers.

The form in which glass fibers are incorporated can either be that of short glass fibers or else that of continuous-filament fibers (rovings). The average length of the glass fibers in the finished injection molding is preferably in the range from 0.08 to 0.5 mm.

Carbon fibers or glass fibers can also be used in the form of textiles, mats, or glass-silk rovings.

Suitable particulate fillers are amorphous silica, carbonates, such as magnesium carbonate and chalk, powdered quartz, mica, various silicates, such as clays, muscovite, biotite, suzoite, tin maletite, talc, chlorite, phlogopite, feldspar, calcium silicates, such as wollastonite, or aluminum silicates, such as kaolin, particularly calcined kaolin.

Preferred particulate fillers are those in which at least 95% by weight, preferably at least 98% by weight, of the particles have a diameter (greatest diameter through the geometric center), determined on the finished product, of less than 45 μm, preferably less than 40 μm, where the value known as the aspect ratio of the particles is in the range from 1 to 25, preferably in the range from 2 to 20, determined on the finished product. The aspect ratio is the ratio of particle diameter to thickness (greatest dimension to smallest dimension, in each case through the geometric center).

The particle diameters can by way of example be determined here by recording electron micrographs of thin layers of the polymer mixture and evaluating at least 25 filler particles, preferably at least 50. The particle diameters can also be determined by way of sedimentation analysis, as in Transactions of ASAE, page 491 (1983). Sieve analysis can also be used to measure the proportion by weight of the fillers with diameter less than 40 μm.

The particulate fillers used particularly preferably comprise talc, kaolin, such as calcined kaolin, or wollastonite, or a mixture of two or all of said fillers. Among these, particular preference is given to talc having a proportion of at least 95% by weight of particles with diameter smaller than 40 μm and with aspect ratio of from 1.5 to 25, in each case determined on the finished product. Kaolin preferably has a proportion of at least 95% by weight of particles with diameter smaller than 20 μm and preferably has an aspect ratio of from 1.2 to 20, which in each case is determined on the finished product.

The thermoplastic molding compositions can moreover comprise further additives and/or processing aids as component D.

### Component D

The molding compositions of the invention can comprise, as constituents of component (D), auxiliaries, in particular processing aids, pigments, stabilizers, flame retardants, or a mixture of various additives. Other examples of conventional additives are oxidation retarders, agents to counteract decomposition by heat and decomposition by ultraviolet light, lubricants and mold-release agents, dyes and plasticizers.

The proportion of component (D) in the molding composition of the invention is in particular from 0 up to 30% by weight, preferably from 0 up to 20% by weight, in particular from 0 to 15% by weight, based on the total weight of components (A) to (D). If component D includes stabilizers, the proportion of said stabilizers is usually up to 2% by weight, preferably from 0.01 to 1% by weight, in particular from 0.01 to 0.5% by weight, based on the total of the % by weight values for components (A) to (D).

The amounts generally comprised of pigments and dyes are from 0 to 6% by weight, preferably from 0.05 to 5% by weight, and in particular from 0.1 to 3% by weight, based on the total of the % by weight values for components (A) to (D).

Pigments for the coloring of thermoplastics are well known, see for example R. Gächter and H. Müller, Taschenbuch der Kunststoffadditive [Plastics additives handbook], Carl Hanser Verlag, 1983, pages 494 to 510. A first preferred group of pigments that may be mentioned are white pigments, such as zinc oxide, zinc sulfide, white lead [2 PbCO₃.Pb(OH)₂], lithopones, antimony white, and titanium dioxide. Of the two most familiar crystalline forms of titanium dioxide (rutile and anatase), it is in particular the rutile form which is used for white coloring of the molding compositions of the invention. Black color pigments which can be used according to the invention are iron oxide black (Fe₃O₄), spinell black [Cu(Cr, Fe)₂O₄], manganese black (a mixture composed of manganese dioxide, silicon dioxide, and iron oxide), cobalt black, and antimony black, and also particularly preferably carbon black, which is mostly used in the form of furnace black or gas black. In this connection see G. Benzing, Pigmente für Anstrichmittel [Pigments for paints], Expert-Verlag (1988), pages 78 ff.

Particular color shades can be achieved by using inorganic chromatic pigments, such as chromium oxide green, or organic chromatic pigments, such as azo pigments or phthalocyanines. Pigments of this type are known to the person skilled in the art.

Examples of oxidation retarders and heat stabilizers which can be added to the thermoplastic molding compositions according to the invention are halides of metals of group I of the Periodic Table of the Elements, e.g. sodium halides, potassium halides, or lithium halides, examples being chlorides, bromides, or iodides. Zinc fluoride and zinc chloride can moreover be used. It is also possible to use sterically hindered phenols, hydroquinones, substituted representatives of said group, secondary aromatic amines, optionally in combination with phosphorus-containing acids, or to use their salts, or a mixture of said compounds, preferably in concentrations up to 1% by weight, based on the total of the % by weight values for components (A) to (D).

Examples of UV stabilizers are various substituted resorcinols, salicylates, benzotriazoles, and benzophenones, the amounts generally used of these being up to 2% by weight.

Lubricants and mold-release agents, the amounts of which added are generally up to 1% by weight, based on the total of the % by weight values for components (A) to (D), are stearyl alcohol, alkyl stearates, and stearamides, and also esters of pentaerythritol with long-chain fatty acids. It is also possible to use dialkyl ketones, such as distearyl ketone.

The molding compositions of the invention comprise, as preferred constituent, from 0.1 to 2% by weight, preferably from 0.1 to 1.75% by weight, particularly preferably from 0.1 to 1.5% by weight, and in particular from 0.1 to 0.9% by weight (based on the total of the % by weight values for components (A) to (D)) of stearic acid and/or stearates. Other stearic acid derivatives can in principle also be used, examples being esters of stearic acid.

Stearic acid is preferably produced via hydrolysis of fats. The resultant products are usually mixtures of stearic acid and palmitic acid. These products therefore have a wide softening range, for example from 50 to 70° C., depending on the constitution of the product. It is preferable to use products having more than 20% by weight stearic acid content, particularly preferably more than 25% by weight. It is also possible to use pure stearic acid (>98%).

Component (D) can moreover also include stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is preferable to use aluminum tristearate.

Further additives that can be used are also those known as nucleating agents, an example being talc.

Components (A) to (D) can be mixed in any desired sequence.

The molding compositions of the invention can be produced by processes known per se, for example extrusion. The molding compositions of the invention can by way of example be produced by mixing the starting components in conventional mixing apparatuses, such as screw-based extruders, preferably twin-screw extruders, Brabender mixers, or Banbury mixers, or else kneaders, and then extruding them. The extrudate is cooled and comminuted. The sequence of the mixing of the components can be varied, and it is therefore possible to mix two or more than two components in advance, but it is also possible to mix all of the components together.

In order to obtain a mixture with maximum homogeneity, intensive and thorough mixing is advantageous. Average mixing times needed for this are generally from 0.2 to 30 minutes at temperatures of from 290 to 380° C., preferably from 300 to 370° C. The extrudate is generally cooled and comminuted.

The thermoplastic molding compositions of the invention can be used advantageously for producing moldings, fibers, foams, films, and membranes. The molding compositions of the invention are particularly suitable for producing moldings for household items, or for electrical or electronic components, as well as for producing moldings for the vehicle sector, and in particular automobiles.

The examples below provide further explanation of the invention without restricting the same.

### EXAMPLES

The moduli of elasticity, ultimate tensile strength, and tensile strain at break of the specimens were determined on dumbbells in the ISO 527 tensile test.

The impact resistance of the products comprising glass fibers was determined on ISO specimens to ISO 179 1eU. The notched impact resistance of the unreinforced products was determined to ISO 179 1eB. In the case of the unreinforced products, tensile strength to ISO 527 was determined instead of ultimate tensile strength.

Flowability was assessed on the basis of melt viscosity. Melt stability was determined by means of a capillary rheometer. Apparent viscosity was determined here at 350° C. as a function of shear rate in a capillary viscometer (Göttfert Rheograph 2003 capillary viscometer) with a circular capillary of length 30 mm, radius 0.5 mm, with a nozzle angle of 180°, with a diameter of 12 mm for the melt reservoir vessel, and with a preheating time of 5 minutes. The values determined at 1000 Hz are stated.

Anisotropy of stiffness was determined as follows, on sheets: sheets of dimensions 150*150*3 mm³ were produced in a mold with film gate. Said sheets were used in each case to produce 5 tensile specimens on a high-speed cutter. The test specimens were cut either in the direction of flow (direction y) or perpendicularly thereto (direction x). Said test specimens were used for determination of modulus of elasticity in the direction of flow and perpendicularly to the direction of flow.

The intrinsic viscosity of the polyarylene ethers was determined in 1% strength N-methylpyrrolidone solution at 25° C. to DIN EN ISO 1628-1.

### Component A

Component A-1 used was a PESU-type polyether sulfone with intrinsic viscosity of 49.0 ml/g (Ultrason® E 1010 from BASF SE). The product used had 0.16% by weight of Cl end groups and 0.21% by weight of OCH₃ end groups.

### Component B

Component B-1 used was a hyperbranched polycarbonate, produced as follows:

The polyfunctional alcohol, diethyl carbonate, and 0.15% by weight of potassium carbonate as catalyst (amount based on amount of alcohol) were used as initial charge in accordance with the batch quantities of table 1 in a three-necked flask equipped with stirrer, reflux condenser, and internal thermometer, and the mixture was heated to 140° C. and stirred at this temperature for 2 h. As reaction time proceeded, the temperature of this reaction mixture decreased, the reason for this being the onset of evaporated cooling by the ethanol liberated. The reflux condenser was then replaced by an inclined condenser, and based on the equivalent amount of catalyst, one equivalent of phosphoric acid was added, ethanol was removed by distillation, and the temperature of the reaction mixture was increased slowly to 160° C. The alcohol removed by distillation was collected in a cooled round-bottomed flask and weighed, and conversion was thus determined and compared in percentage terms with the full conversion theoretically possible (see table 1).

Dry nitrogen was then passed at 160° C. through the reaction mixture for a period of 1 h, in order to remove any residual amounts of monomers present. The reaction mixture was then cooled to room temperature.

Analysis of the polycarbonates of the invention:

The polycarbonates were analyzed by gel permeation chromatography using a refractometer as detector. The mobile phase used was dimethylacetamide, and the standard used for molecular weight determination was polymethyl methacrylate (PMMA).

OH number was determined to DIN 53240, part 2.

TABLE 1
Starting materials and final products

| | | | Molar mass | OH number of |
|---|---|---|---|---|
| | Molar | Distillate, amount of | of product | product |
| | ratio of | alcohol, based on | (g/mol) | (mg KOH/g) |
| | alcohol to | complete conversion | Mw | to DIN 53240, |
| Alcohol | carbonate | mol % | Mn | part 2 |
| TMP × | 1:1 | 72 | 2300 | 400 |
| 1.2 PO | | | 1500 | |

TMP = trimethylolpropane
PO = propylene oxide

The expression “TMP×1.2 PO” here describes a product which, per mole of trimethylolpropane, has been reacted with an average of 1.2 mol of propylene oxide.

### Component C

Component C-1 used was chopped glass fibers with staple length 4.5 mm and fiber diameter 10 μm, coated with a polyurethane size.

TABLE 2
Composition and properties of thermoplastic molding compositions.

| Example | comp 1 | 2 | 3 | comp 4 | 5 | 6 |
|---|---|---|---|---|---|---|
| Component A-1 | 70 | 69.5 | 69 | 100 | 99.5 | 99 |
| Component B-1 | — | 0.5 | 1 | — | 0.5 | 1 |
| Component C-1 | 30 | 30 | 30 | — | — | — |
| Modulus of elasticity [GPa] | 9.7 | 9.9 | 9.9 | 2.80 | 2.81 | 2.80 |
| Tensile strain at break [%] | 2.4 | 2.4 | 2.3 | >40 | >40 | >40 |
| Ultimate tensile strength/Tensile | 139 | 142 | 143 | 81.2 | 80.6 | 80.5 |
| strength [MPa] | | | | | | |
| ISO 179 1eU [kJ/m²] | 51 | 51 | 50 | n.d. | n.d. | n.d. |
| ISO 179 1 eB [kJ/m²] | — | — | — | 37 | 78 | 89 |
| Viscosity at 1000 Hz (350° C.) | 531 | 476 | 423 | 280 | 244 | 212 |
| Modulus of elasticity of a sheet | 8.3 | 8.5 | 8.5 | n.d. | n.d. | n.d. |
| (flow direction y) [GPa] | | | | | | |
| Modulus of elasticity of a sheet | 5.4 | 6.1 | 6.4 | n.d. | n.d. | n.d. |
| (x direction) [GPa] | | | | | | |

The composition of the thermoplastic molding compositions is given in parts by weight.
(comp = comparative example, n.d. = not determined).

Table 2 shows that the molding compositions of the invention feature improved flowability while simultaneously having good mechanical properties. When compared with the prior art, the unreinforced molding compositions of the invention have markedly improved flowability, and also markedly improved notched impact resistance. When compared with the prior art, the reinforced thermoplastic molding compositions of the invention have markedly improved flowability, and also high stiffness, the anisotropy of which has been reduced.

1-12. (canceled)

13. A thermoplastic molding composition comprising the following components:
(A) at least one polyarylene ether,
(B) at least one hyperbranched polymer selected from hyperbranched polycarbonates and hyperbranched polyesters,
(C) optionally at least one fibrous or particulate filler, and
(D) optionally further additives and/or processing aids.

14. The thermoplastic molding composition according to claim 13, comprising from 90 to 99.9% by weight of component (A) and from 0.1 to 10% by weight of component (B), where the total of the % by weight values of components (A) and (B), based on the entire amount of components (A) and (B), is 100% by weight.

15. The thermoplastic molding composition according to claim 13, comprising from 25 to 94.9% by weight of component (A), from 0.1 to 5% by weight of component (B), from 5 to 70% by weight of component (C), and from 0 to 40% by weight of component (D), where the total of the % by weight values of components (A) to (D), based on the entire amount of components (A) to (D), is 100% by weight.

16. The thermoplastic molding composition according to claim 13, wherein component (B) comprises at least one hyperbranched polyester of AₓB_{y} type, where x is at least 1 and y is at least 2.

17. The thermoplastic molding composition according to claim 14, wherein component (B) comprises at least one hyperbranched polyester of AₓB_{y} type, where x is at least 1 and y is at least 2.

18. The thermoplastic molding composition according to claim 15, wherein component (B) comprises at least one hyperbranched polyester of AₓB_{y} type, where x is at least 1 and y is at least 2.

19. The thermoplastic molding composition according to claim 13, wherein the polyarylene ethers of component (A) are composed of units of the general formula I: 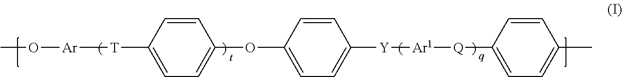
where the definitions are as follows
t and q: independently of one another 0, 1, 2, or 3,
Q, T and Y: independently of one another in each case a chemical bond or group selected from —O—, —S—, —SO₂—, S═O, C═O, —N═N— and —CR^{a}R^{b}—, where R^{a} and R^{b} independently of one another are in each case a hydrogen atom or a C₁-C₁₂-alkyl, C₁-C₁₂-alkoxy or C₆-C₁₈-aryl group, and where at least one of Q, T and Y is —SO₂— and
Ar and Ar¹: independently of one another a C₆-C₁₈-arylene group.

20. The thermoplastic molding composition according to claim 13, wherein component (A) is composed of at least one polyarylene ether sulfone.

21. The thermoplastic molding composition according to claim 17, wherein component (A) is composed of at least one polyarylene ether sulfone.

22. The thermoplastic molding composition according to claim 18, wherein component (A) is composed of at least one polyarylene ether sulfone.

23. The thermoplastic molding composition according to claim 19, wherein Q, T and Y in formula (I) have been selected independently of one another from —O— and —SO₂—, and at least one of Q, T, and Y is —SO₂—.

24. The thermoplastic molding composition according to claim 19, wherein Ar and Ar¹ in formula (I) have been selected independently of one another from the group consisting of 1,4-phenylene, 1,3-phenylene, naphthylene, and 4,4′-bisphenylene.

25. The thermoplastic molding composition according to claim 13, wherein component (C) is required and composed of glass fibers.

26. The thermoplastic molding composition according to claim 21, wherein component (C) is required and composed of glass fibers.

27. The thermoplastic molding composition according to claim 22, wherein component (C) is composed of glass fibers.

28. A process for producing the thermoplastic molding composition according to claim 13, comprising the mixing of components (A) and (B) and optionally components (C) and (D) in a mixing apparatus.

29. A process for producing moldings, fibers, foams, films, or membranes which comprises utilizing the thermoplastic molding composition according to claim 13.

30. A molding, a fiber, a foam, a film, or a membrane, comprising the thermoplastic molding composition according to claim 13.
